(19) United States
(12) Patent Application Publication
(10) Pub. No.: US 2024/0318486 A1
(43) Pub. Date: Sep. 26, 2024

(54) UNIVERSAL POCKET DOOR FRAME DOOR STOP AND METHODS OF USING SAME

(71) Applicant: The Marwin Company, West Columbia, SC (US)

(72) Inventor: Mark R. SENDAR, West Columbia, SC (US)

(21) Appl. No.: 18/610,985

(22) Filed: Mar. 20, 2024

Related U.S. Application Data
(60) Provisional application No. 63/453,349, filed on Mar. 20, 2023.

(51) Int. Cl. E05F 5/02

(52) U.S. Cl. CPC E05F 5/02

(57) ABSTRACT

A universal pocket door frame door stop apparatus for mounting on a door frame, comprising: a main body with two downturned sides; a bumper mount disposed on a front of the main body; and, a bumper attached to the bumper mount.

### RELATED APPLICATION

This application claims the benefit of priority under 35 USC § 119(e) of U.S. Provisional Patent Application No. 63/453,349 filed Mar. 20, 2023, the contents of which are incorporated herein by reference in their entirety.

### FIELD OF THE INVENTION

The present invention, in some embodiments thereof, relates to the construction industry and, more particularly, but not exclusively, to door frames.

### BACKGROUND OF THE INVENTION

An assembled pocket door frame is typically built to the size of the door. Although there is no standard size, common size widths include 2′0″, 2′2″. 2′4″, 2′6″, 2′8″, 2′10″ and 3′0″ in both 6′8″ and 8′0″ heights. Inventorying all these different sizes requires significant square footage and also the ability to forecast which sizes will sell in a timely manner. Furthermore, there is an increased burden on manufacturing since different lines need to be created to manufacture different door frame sizes.

### SUMMARY OF THE INVENTION

According to an aspect of some embodiments of the present invention there is provided a universal pocket door frame door stop apparatus for mounting on a door frame, comprising: a main body with two downturned sides; a bumper mount disposed on a front of the main body; and, a bumper attached to the bumper mount.

In an embodiment of the invention, the main body is generally shaped with an upper, largely planar surface,

In an embodiment of the invention, two sides are disposed on each side of the upper surface of the main body, respectively, and in an axis substantially transverse to the upper surface.

In an embodiment of the invention, the bumper mount is directed in an upward direction opposite a downturned direction of the sides.

In an embodiment of the invention, the apparatus further comprises a bumper mounting aperture which traverses through the bumper mount for attaching the bumper thereto.

In an embodiment of the invention, a nut is used to secure the bumper to the bumper mount by screwing onto threading located on the bumper.

In an embodiment of the invention, the bumper is screwed directly into the bumper mount using a threaded screw-type arrangement.

In an embodiment of the invention, a self-tapping screw is used to secure the bumper to the bumper mount.

In an embodiment of the invention, the bumper is snapped into the bumper mount.

In an embodiment of the invention, the bumper is fastened into the bumper mount using a cotter pin configuration.

In an embodiment of the invention, the main body is constructed from a metal, an alloy, plastic, polymer or wood.

In an embodiment of the invention, the bumper is made from a resilient material such as rubber, plastic or a polymer.

In an embodiment of the invention, the apparatus further comprises at least one guide configured to assist with aligning and stabilizing the apparatus to and with at least one purlin of the door frame.

In an embodiment of the invention, the apparatus further comprises a space between the at least one guide and one of the sides wherein one purlin would be positioned when the apparatus is installed in the door frame.

In an embodiment of the invention, the apparatus is secured to the at least one purlin using fasteners such as screws or nails or the like.

In an embodiment of the invention, the apparatus is configured with at least one fastening hole disposed within the main body and aligned with the at least one purlin on which the apparatus is mounted.

In an embodiment of the invention, the apparatus further comprises at least one snare.

In an embodiment of the invention, the apparatus is constructed of a substantially rectangular plate.

In an embodiment of the invention, the bumper mount, and at least one guide are formed from the same plate for ease and cost efficiency of manufacturing.

In an embodiment of the invention, the bumper extends at least slightly past a front edge of the main body of the apparatus.

According to an aspect of some embodiments of the present invention there is provided a universal pocket door frame door stop system, comprising: a pocket door frame; a pocket door; and, a universal pocket door frame door stop apparatus for mounting on a door frame, comprising: a main body with two downturned sides; a bumper mount disposed on a front of the main body; and, a bumper attached to the bumper mount, wherein placement indicators are placed on the door frame, for example on purlins of the door frame, where the placement indicators are pre-marked on the door frame to correspond to known different pocket door sizes, such that no measurements need to be made by a door frame installer during installation of the pocket door frame system.

According to an aspect of some embodiments of the present invention there is provided a method is using a universal pocket door frame door stop apparatus, comprising: ascertaining the size of a pocket door to be installed; installing a pocket door frame; and, placing the universal pocket door frame door stop apparatus in the pocket door frame.

In an embodiment of the invention, the door stop apparatus is placed on at least one purlin of the pocket door frame.

In an embodiment of the invention, the method further comprises attaching the door stop apparatus to the pocket door frame using at least one fastener or snare.

According to an aspect of some embodiments of the present invention there is provided a method of making a universal pocket door frame door stop apparatus, comprising: cutting a planar and substantially rectangular plate; forming at least one side, at least one bumper mount and/or at least one guide from the plate.

In an embodiment of the invention, the method further comprises attaching a bumper to the at least one bumper mount.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example, are not necessarily to scale and are for purposes of illustrative discussion of embodiments of the invention. In this regard, the description taken with the drawings makes apparent to those skilled in the art how embodiments of the invention may be practiced.

In the drawings:

FIG. 1 is a top, front perspective view of a universal pocket door frame door stop apparatus, in accordance with an exemplary embodiment of the invention;

FIG. 2 is a bottom, front perspective view a universal pocket door frame door stop apparatus, in accordance with an exemplary embodiment of the invention;

FIG. 3 is a front view of a universal pocket door frame door stop apparatus, in accordance with an exemplary embodiment of the invention;

FIG. 4 is a rear view of a universal pocket door frame door stop apparatus, in accordance with an exemplary embodiment of the invention;

FIG. 5 is a right side view of a universal pocket door frame door stop apparatus, in accordance with an exemplary embodiment of the invention;

FIG. 6 is a left side view of a universal pocket door frame door stop apparatus, in accordance with an exemplary embodiment of the invention;

FIG. 7 is a top view of a universal pocket door frame door stop apparatus, in accordance with an exemplary embodiment of the invention;

FIG. 8 is a bottom view of a universal pocket door frame door stop apparatus, in accordance with an exemplary embodiment of the invention;

FIG. 9 is a perspective view of a door stop apparatus installed on a pocket door frame, in accordance with an exemplary embodiment of the invention;

FIG. 10 is perspective close-up view of a door stop apparatus installed on a pocket door frame, in accordance with an exemplary embodiment of the invention;

FIG. 11 is a flowchart of a method of using a universal pocket door frame door stop apparatus, in accordance with an exemplary embodiment of the invention; and,

FIG. 12 is a flowchart of method of creating a system of a plurality of pocket door sizes, at least one universal pocket door frame door stop apparatus and at least one pocket door frame.

### DESCRIPTION OF SPECIFIC EMBODIMENTS OF THE INVENTION

The present invention, in some embodiments thereof, relates to the construction industry and, more particularly, but not exclusively, to door frames.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

Briefly, the apparatuses described herein allow for advances in the building industry by providing a universal pocket door frame door stop which, when used in combination with at least one door and a door frame, allows for a universal or near-universal door frame size to be used with a plurality of different door sizes. As will become readily apparent from the disclosure of the invention herein, the use of a universal pocket door frame door stop enables manufacturing efficiency (at least because less door frame sizes have to be made, avoiding time consuming and expensive retooling), transportation efficiency (at least because less door frame sizes have to be accommodated/packed during transport), storage efficiency (at least because fewer door frame sizes need to be inventoried and stored), and construction design and execution efficiency (at least because less door frame sizes have to be planned for and installed). Additionally, custom door sizes can be used without the requirement of the manufacture of custom-sized door frames to match.

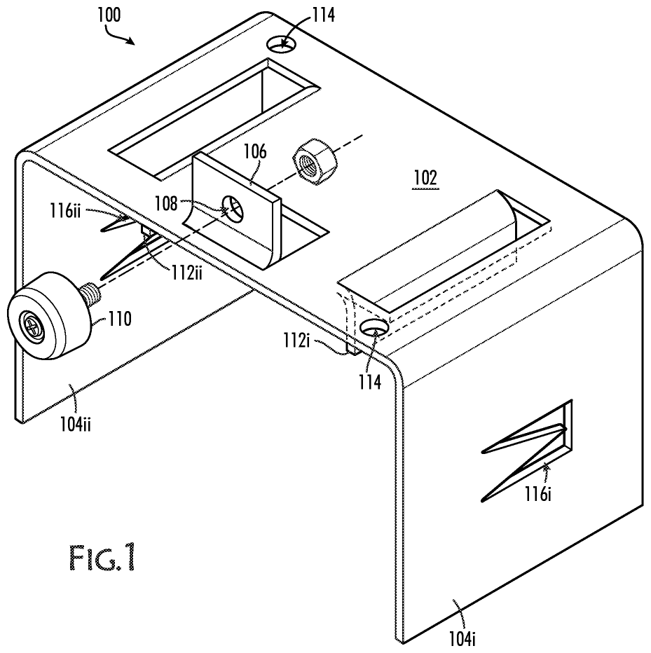

Referring now to the drawings, FIG. 1 is a top, front perspective view of a universal pocket door frame door stop apparatus 100, in accordance with an exemplary embodiment of the invention. In an embodiment of the invention, the apparatus 100 includes a main body 102 generally shaped with an upper, largely planar surface with two downturned sides 104i, 104ii, disposed on each side of the upper surface, respectively, and in an axis substantially transverse to the upper surface. At least one optional bumper mount 106 is disposed near the front of the main body 102 directed in an upward direction opposite the direction of the sides 104i, 104ii, in some embodiments of the invention. It should be understood that the bumper mount 106 could extend downwardly or to the side in some embodiments. A bumper mounting aperture 108 traverses through the bumper mount 106 for attaching a bumper 110 thereto. In some embodiments of the invention, a nut is used to secure the bumper 110 the bumper mount 106 by screwing onto threading located on the bumper. In some embodiments of the invention, a self-tapping screw is used to secure the bumper 110 to the bumper mount 106. In some embodiments of the invention, the main body 102 is constructed from a metal, an alloy, plastic, polymer or wood.

In an embodiment, the bumper 110 is made from a resilient material such as rubber, plastic, polymer, or something similar, such that a door could impact the bumper 110 without being damaged. It should be understood that in some embodiments, a bumper is attached to the main body 102 without using any kind of bumper mount 106, for example by attaching it directly to the front of the apparatus 100 such that it would be positioned between a door and the apparatus 100. Optionally, no bumper 110 is used at all, for example, the main body 102 includes an impact zone designed for repetitive impact of the door on the apparatus 100 without the need for a separate bumper structure.

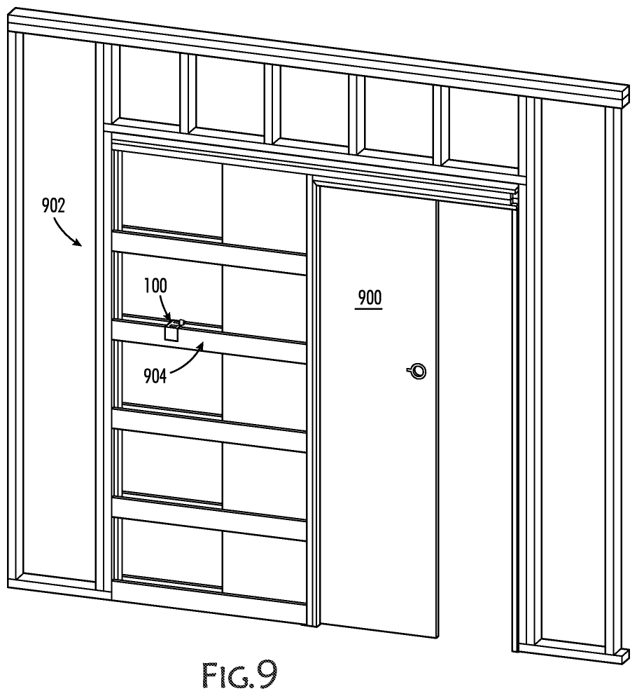

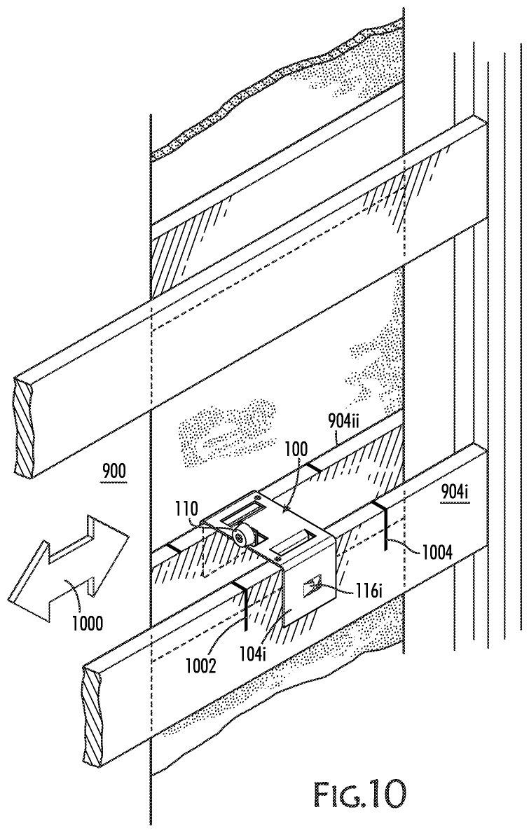

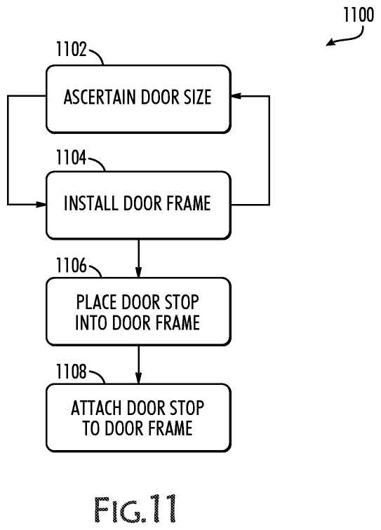

As will be described in more detail below with respect to FIGS. 9 and 10 in particular, the apparatus 100 is designed to be mounted on a purlin 904 (or a pair of purlins 904i, 904ii) of a door frame 902, for example by having at least one guide 112i, 112ii designed to assist with aligning and stabilizing the apparatus 100 to and with the purlin 904. In an embodiment of the invention, two guides 112i, 112ii are used to enhance the aligning and stabilizing.

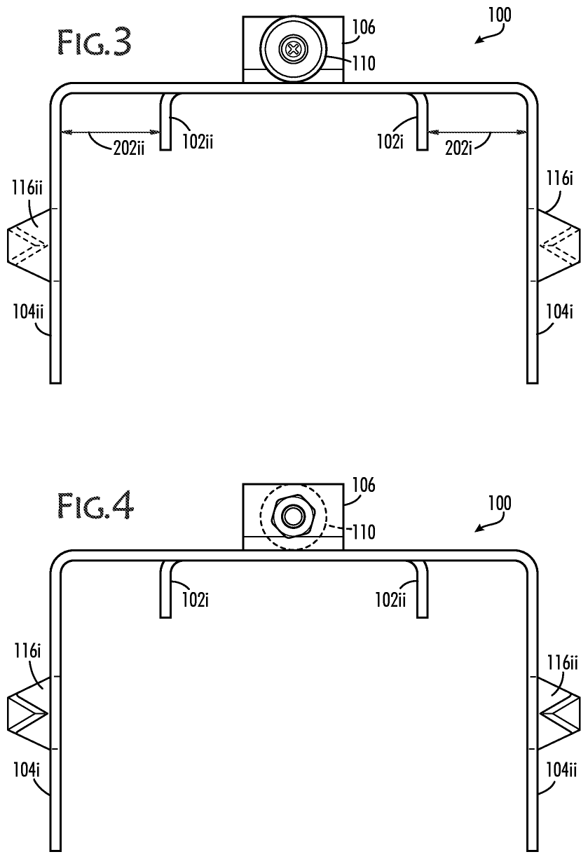

In some embodiments of the invention, the apparatus 100 is secured to the purlin 904 using fasteners such as screws or nails or the like by way of at least one fastening hole 114 disposed within the main body 102, which of course is configured to be aligned with the purlin 904 on which the apparatus 100 is mounted such that the fastener would pass through the fastener hole 114 and into the purlin 904, thereby securing the apparatus 100 to the purlin 904. In some embodiments of the invention, there is at least one fastener hole 114 on each side of the main body 102, for example to align with two sides 904i, 904ii of a purlin 904. Additionally, alternatively and/or optionally, at least one snare 116, a.k.a. a “speed prong”, is cut into at least one of the sides 104i, 104ii which can be driven into the purlin 904 to help secure the apparatus 100 to the purlin 904. In FIG. 1, the at least one snare 116 is shown in a pre-installation configuration, for example just after manufacture and/or during transport. FIGS. 3-8 and 10 show the at least one snare 116 in an installation configuration, described in more detail below.

In an embodiment of the invention, the apparatus 100 is constructed of a substantially rectangular plate and wherein most or all of the features comprising the sides 104i, 104ii, the bumper mount 106, and the guides 112i 112ii are formed from the same plate, for ease and cost efficiency of manufacturing.

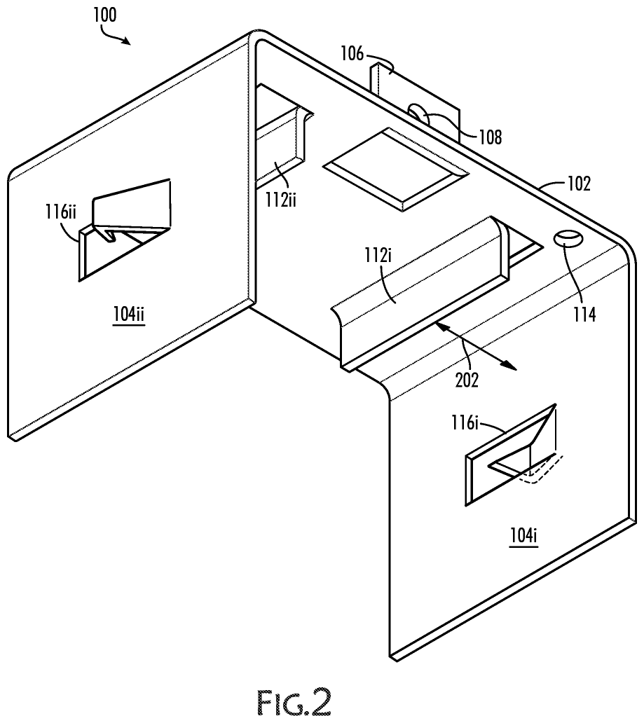

FIG. 2 is a bottom, front perspective view the universal pocket door frame door stop apparatus 100, in accordance with an exemplary embodiment of the invention. FIG. 2 more clearly shows a space 202 between a guide 112i and a side 104i where a purlin side 904i would be positioned when the apparatus 100 is installed in a door frame 902.

FIG. 3 is a front view of the universal pocket door frame door stop apparatus 100, in accordance with an exemplary embodiment of the invention. As can be more clearly seen in FIG. 3, spaces 202 for purlins 904i, 904ii are disposed between the guides 112i, 112ii and the sides 104i, 104ii. It should be understood that while spaces 202 are shown approximately equal in size, they do not necessarily need to be. Additionally, there doesn't need to be two, such as shown, there could be none, one, or more than two guides. FIG. 3 also shows the bumper 110 attached to the bumper mount 106 facing the front, in an embodiment of the invention.

In some embodiments of the invention, snares 116i, 116ii are provided to each side 104i, 104ii, respectively, wherein the snares 116 are cut into the sides during manufacture, and for apparatus 100 installation are bent outwardly into the installation configuration shown in FIGS. 3-8 so that they can be driven into the underlying purlin 904i, 904ii. It should be understood that the snares 116 are optional and/or even if they are present, use of them is optional, for example if fasteners are used to attached the apparatus 100 to at least one purlin 904 through a fastener hole 114. Optionally, there is just one snare. Optionally, there are more than two snares.

FIG. 4 is a rear view of the universal pocket door frame door stop apparatus 100, in accordance with an exemplary embodiment of the invention. In some embodiments of the invention, the bumper 110 is screwed into the bumper mount 106, for example using a threaded screw-type arrangement. Optionally, the bumper 110 is snapped into the bumper mount 106. Optionally, the bumper 110 is fastened into the bumper mount 106, for example using a cotter pin configuration.

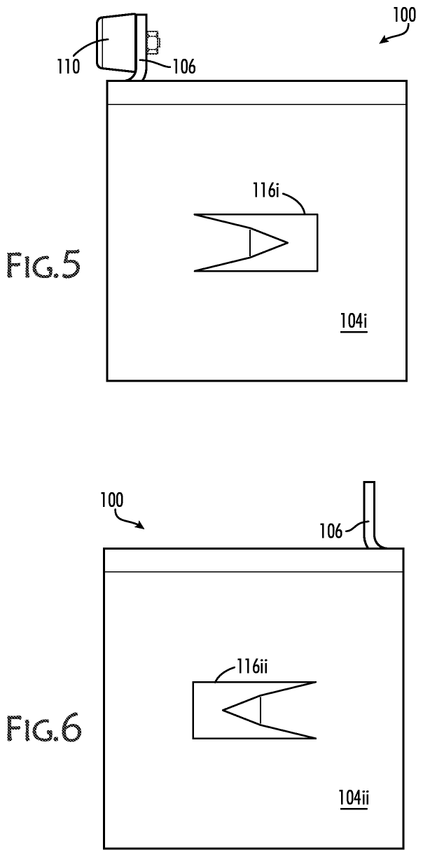

FIG. 5 is a right side view of the universal pocket door frame door stop apparatus 100, in accordance with an exemplary embodiment of the invention. In this view, a snare 116i is shown in more detail in an initial configuration prior to deployment of the apparatus 100 in the field (i.e. on a door frame). In an embodiment of the invention at least one snare 116 is cut into one or more sides 104 of the apparatus 100 at the time of manufacture, with an end configured for insertion into an underlying purlin 904, for example by being pointed and/or having a tip. This side view shows the bumper 110 attached to the bumper mount 106 by a threaded post, which in this embodiment, extends through the mounting aperture 108.

FIG. 6 is a left side view of the universal pocket door frame door stop apparatus 100 without the bumper 110 attached, in accordance with an exemplary embodiment of the invention.

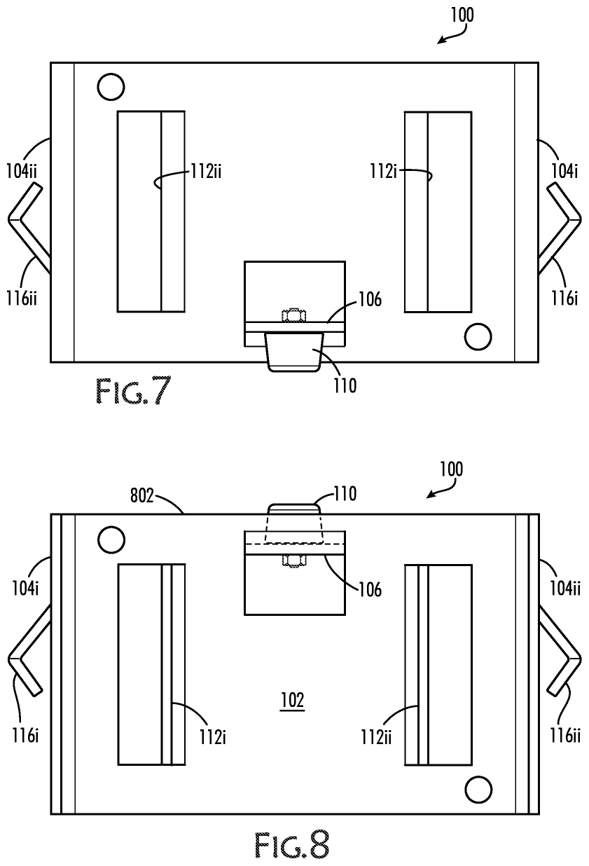

FIG. 7 is a top view of the universal pocket door frame door stop apparatus 100, in accordance with an exemplary embodiment of the invention. It can be seen more clearly from FIG. 7 that the guides 112i, 112ii can be cut from the same substantially rectangular plate as other features, such as the bumper mount 106. In some embodiments of the invention, the guides 112 and/or the bumper mount 106 are cut with one end remaining attached to the main body 102 and then bent downwardly or upwardly. In some embodiments of the invention, the sides 104i, 104ii are also bent downwardly (or upwardly) to define them as sides to the apparatus 100.

FIG. 8 is a bottom view of a universal pocket door frame door stop apparatus, in accordance with an exemplary embodiment of the invention. In an embodiment of the invention, bumper 110 can be seen extending at least slightly past the front edge 802 of the main body 102 of the apparatus 100 with the objective being that a door closing onto the apparatus 100 would hit the bumper 110 harmlessly, before hitting the main body 102 of the apparatus 100.

FIG. 9 is a perspective view of the door stop apparatus 100 installed on the pocket door frame 902, in accordance with an exemplary embodiment of the invention. In an embodiment of the invention, the apparatus 100 is placed on the purlin 904 (or a matching pair of purlins 904i, 904ii) in a desired location such that when the door 900 closes 1000, it will harmlessly hit the door stop apparatus 100 (i.e. the bumper 110, in some embodiments) and stop where intended. Optionally, a plurality of door stop apparatuses 100 are used (e.g. by placing them on purlins above and/or below each other in the door frame).

FIG. 10 is perspective close-up view of the door stop apparatus 100 installed on the pocket door frame 902, in accordance with an exemplary embodiment of the invention. It should be understood that in some embodiments of the invention, the door stop apparatus 100 and the door frame 902 form a system wherein placement indicators 1002, 1004 on the door frame 902, for example on the purlins 904i, 904ii, are pre-marked to correspond to known different door 900 sizes, such that no measurements need to be made by the door frame installer, highly simplifying, making more efficient, and enhancing construction quality of this construction task.

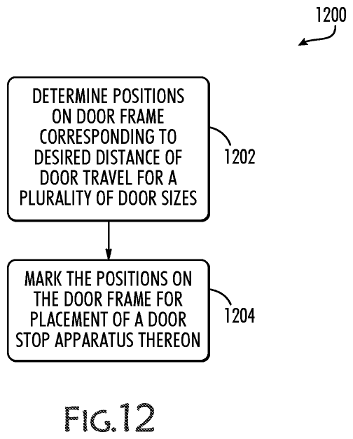

FIG. 11 is a flowchart 1100 of a method of using the universal pocket door frame door stop apparatus 100, in accordance with an exemplary embodiment of the invention. In an embodiment of the invention, a size of a pocket door 900 being installed is ascertained (1102). A pocket door frame 902 is installed (1104) at a construction site, either before or after the ascertaining of the pocket door size, in an embodiment of the invention. In an embodiment of the invention, the door stop apparatus 100 is placed (1106) onto a purlin 904 of the door frame 902 wherein the placement of the door stop apparatus is matched to the door size such that the pocket door 900 will only close within the pocket door frame to a desired extent before harmlessly stopping at the door stop apparatus 100. Optionally, the door stop 100 is attached (1108) to the door frame, for example by using at least one fastener or snare 116.

In some embodiments of the invention, a plurality of doors 900, the at least one door stop apparatus 100 and at least one door frame 902 form a system wherein multiple door sizes can be used with a single door frame size, where the door stop adjusts the extent of travel of the door when the door stop 100 is installed in the door frame. In the furtherance of the system, and as shown in the flowchart 1200 of FIG. 12, at least one placement indicator 1002, 1004 is marked (1204) onto the door frame 902 in positions for placement of the door stop apparatus 100 which have been determined (1202) to correspond to different door sizes and/or desired range of travel of the doors. In some embodiments of the invention, a few pocket door frame sizes are each associated with a plurality of pocket door sizes and/or configurations. Optionally, a plurality of door stop apparatuses 100 are used (e.g. by placing them on purlins above and/or below each other in the door frame).

It is expected that during the life of a patent maturing from this application many relevant door frame stops will be developed and the scope of the term “stop” is intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality” means “two or more”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A universal pocket door frame door stop apparatus for mounting on a door frame, comprising:
a main body with two downturned sides;
a bumper mount disposed on a front of the main body; and,
a bumper attached to the bumper mount.

2. The universal pocket door frame door stop apparatus according to claim 1, wherein the main body is generally shaped with an upper, largely planar surface,

3. The universal pocket door frame door stop apparatus according to claim 2, wherein the two sides are disposed on each side of the upper surface of the main body, respectively, and in an axis substantially transverse to the upper surface.

4. The universal pocket door frame door stop apparatus according to claim 1, wherein the bumper mount is directed in an upward direction opposite a downturned direction of the sides.

5. The universal pocket door frame door stop apparatus according to claim 1, further comprising a bumper mounting aperture which traverses through the bumper mount for attaching the bumper thereto.

6. The universal pocket door frame door stop apparatus according to claim 1, wherein a nut is used to secure the bumper to the bumper mount by screwing onto threading located on the bumper.

7. The universal pocket door frame door stop apparatus according to claim 1, wherein the bumper is screwed directly into the bumper mount using a threaded screw-type arrangement.

8. The universal pocket door frame door stop apparatus according to claim 1, wherein a self-tapping screw is used to secure the bumper to the bumper mount.

9. The universal pocket door frame door stop apparatus according to claim 1, wherein the bumper is snapped into the bumper mount.

10. The universal pocket door frame door stop apparatus according to claim 1, wherein the bumper is fastened into the bumper mount using a cotter pin configuration.

11. The universal pocket door frame door stop apparatus according to claim 1, wherein the main body is constructed from a metal, an alloy, plastic, polymer or wood.

12. The universal pocket door frame door stop apparatus according to claim 1, wherein the bumper is made from a resilient material such as rubber, plastic or a polymer.

13. The universal pocket door frame door stop apparatus according to claim 1, further comprising at least one guide configured to assist with aligning and stabilizing the apparatus to and with at least one purlin of the door frame.

14. The universal pocket door frame door stop apparatus according to claim 13, further comprising a space between the at least one guide and one of the sides wherein one purlin would be positioned when the apparatus is installed in the door frame.

15. The universal pocket door frame door stop apparatus according to claim 13, wherein the apparatus is secured to the at least one purlin using fasteners such as screws or nails or the like.

16. The universal pocket door frame door stop apparatus according to claim 15, wherein the apparatus is configured with at least one fastening hole disposed within the main body and aligned with the at least one purlin on which the apparatus is mounted.

17. The universal pocket door frame door stop apparatus according to claim 1, further comprising at least one snare.

18. The universal pocket door frame door stop apparatus according to claim 1, wherein the apparatus is constructed of a substantially rectangular plate.

19. The universal pocket door frame door stop apparatus according to claim 18, wherein the sides, the bumper mount, and at least one guide are formed from the same plate for ease and cost efficiency of manufacturing.

20. The universal pocket door frame door stop apparatus according to claim 1, wherein the bumper extends at least slightly past a front edge of the main body of the apparatus.

21. A universal pocket door frame door stop system, comprising:
a pocket door frame;
a pocket door; and,
a universal pocket door frame door stop according to claim 1,
wherein placement indicators are placed on the door frame, for example on purlins of the door frame, where the placement indicators are pre-marked on the door frame to correspond to known different pocket door sizes, such that no measurements need to be made by a door frame installer during installation of the pocket door frame system.

22. A method is using a universal pocket door frame door stop apparatus, comprising:
ascertaining the size of a pocket door to be installed;
installing a pocket door frame; and,
placing the universal pocket door frame door stop apparatus of claim 1 in the pocket door frame.

23. The method according to claim 22, wherein the door stop apparatus is placed on at least one purlin of the pocket door frame.

24. The method according to claim 22, further comprising attaching the door stop apparatus to the pocket door frame using at least one fastener or snare.
